(19) United States
(12) Patent Application Publication
(10) Pub. No.: US 2025/0278743 A1
(43) Pub. Date: Sep. 4, 2025

(54) INTELLIGENT FEEDBACK SYSTEM

(71) Applicant: Profit Pro Inc., Beverly, MA (US)

(72) Inventor: Joseph Gerbino, Wenham, MA (US)

(73) Assignee: Profit Pro Inc., Beverly, MA (US)

(21) Appl. No.: 19/066,660

(22) Filed: Feb. 28, 2025

Related U.S. Application Data
(60) Provisional application No. 63/559,282, filed on Feb. 29, 2024.

(51) Int. Cl. G06Q 30/015; G06F 40/35; G06Q 30/0601

(52) U.S. Cl. CPC G06Q 30/015; G06F 40/35; G06Q 30/0613

(57) ABSTRACT

A computing system receives, in real-time or near real-time, a transcript of an ongoing conversation between a first user and an individual via a first user device. The computing system generates real-time or near real-time feedback to the first user by interfacing with a large language model fine-tuned using pairs of historic conversations and corresponding success states to determine that the individual conveyed a message to the first user that includes an objection and generate a proposed response to address the objection based on a context of the ongoing conversation. The computing system causes display of the proposed response in real-time or near real-time via the first user device.

### FIELD OF DISCLOSURE

The present disclosure generally relates to the field of sales training enhancement, and more specifically, to systems and methods that utilize artificial intelligence and machine learning models to identify customer objections and provide targeted micro-training to sales consultants.

### BACKGROUND

Sales training has been a cornerstone of business development for many years. Traditional methods often involve group training sessions led by experienced sales professionals. These sessions typically focus on teaching sales consultants how to handle customer objections using specific word tracks. The goal is to equip sales consultants with the skills and knowledge to effectively address customer concerns and close sales.

One common approach in these training sessions is the use of role-play scenarios. In these scenarios, sales consultants are given the opportunity to practice their responses to various customer objections. This method allows sales consultants to gain practical experience in a controlled environment before interacting with actual customers.

Another prevalent technique in sales training is the use of scripts. Scripts provide sales consultants with a predefined set of responses to common customer objections. These scripts are often developed by top-level sales professionals and are intended to guide sales consultants in their interactions with customers.

With the advent of technology, sales training has also seen the integration of digital tools. For instance, mobile applications have been used to provide sales consultants with on-demand access to training materials. These applications often include features such as video tutorials, interactive quizzes, and progress tracking to enhance the learning experience.

### SUMMARY

In some embodiments, a method is disclosed herein. A computing system receives, in real-time or near real-time, a transcript of an ongoing conversation between a first user and an individual via a first user device. The computing system generates real-time or near real-time feedback to the first user by interfacing with a large language model fine-tuned using pairs of historic conversations and corresponding success states to determine that the individual conveyed a message to the first user that includes an objection and generate a proposed response to address the objection based on a context of the ongoing conversation. The computing system causes display of the proposed response in real-time or near real-time via the first user device.

In some embodiments, a non-transitory computer readable medium is disclosed herein. The non-transitory computer readable medium includes one or more sequences of instructions, which, when executed by a processor, causes a computing system to perform operations. The operations include receiving, by the computing system, in real-time or near real-time, a transcript of an ongoing conversation between a first user and an individual via a first user device. The operations further include generating, by the computing system, real-time or near real-time feedback to the first user by interfacing with a large language model fine-tuned using pairs of historic conversations and corresponding success states to determine that the individual conveyed a message to the first user that includes an objection and generate a proposed response to address the objection based on a context of the ongoing conversation. The operations further include causing, by the computing system, display of the proposed response in real-time or near real-time via the first user device.

In some embodiments, a system is disclosed herein. The system includes a processor and a memory. The memory has programming instructions stored thereon, which, when executed by the processor, causes the system to perform operations. The operations include receiving, in real-time or near real-time, a transcript of an ongoing conversation between a first user and an individual via a first user device. The operations further include generating real-time or near real-time feedback to the first user by interfacing with a large language model fine-tuned using pairs of historic conversations and corresponding success states to determine that the individual conveyed a message to the first user that includes an objection and generate a proposed response to address the objection based on a context of the ongoing conversation. The operations further include causing display of the proposed response in real-time or near real-time via the first user device.

### BRIEF DESCRIPTION OF FIGURES

The accompanying drawings, which are incorporated herein and form part of the specification, illustrate the present disclosure and, together with the description, further serve to explain the principles of the present disclosure and to enable a person skilled in the relevant art(s) to make and use embodiments described herein.

FIG. 1 illustrates an exemplary embodiment of a system environment for enhancing sales training, according to aspects of the present disclosure.

FIG. 2 depicts an exemplary embodiment of a computing system for improving sales training methods, related to the system environment of FIG. 1, according to aspects of the present disclosure.

FIG. 3 a flow diagram illustrating a method of training a machine learning model to guide a user through a conversation with a customer, according to example embodiments.

FIG. 4 depicts an exemplary embodiment of a computing system for improving sales training methods, related to the system environment of FIG. 1, according to aspects of the present disclosure.

FIG. 5 is a flow diagram illustrating a method of using artificial intelligence to guide a user through a conversation with a customer, according to example embodiments.

FIG. 6A-6C illustrate exemplary graphical user interfaces (GUIs), according to example embodiments.

FIG. 7A is a block diagram illustrating a computing device, according to example embodiments of the present disclosure.

FIG. 7B is a block diagram illustrating a computing device, according to example embodiments of the present disclosure.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

One or more techniques described herein generally relate to a system and method for enhancing sales training using artificial intelligence and machine learning models. In particular, one or more techniques described herein provide a mobile application that records and transcribes individual customer interactions. Further, according to particular aspects of the present disclosure, the mobile application may include an artificial intelligent model trained to identify customer objections and provide targeted micro-training to sales consultants.

More specifically, the mobile application of the present disclosure may include features such as recording and transcription of customer interactions, identification of customer objections and buying signals, and provision of AI suggestions on how to overcome customer objections. In some embodiments, the mobile application may also generate tips on how to avoid customer objections altogether and assist in negotiating with customers trading in a vehicle on which they are still making payments. The mobile application may be designed to provide micro-training to sales consultants, focusing on missed opportunities identified during customer interactions.

In some embodiments, the mobile application may include an artificial intelligent model, which as will be further described herein, may be trained to identify when a sales consultant is failing to handle customer objections. In effect, the artificial intelligent model is designed to provide targeted training to sales consultants based on their individual performance and identified areas of improvement. As a result, the mobile application may be more effective at improving sales consultant performance, compared to traditional group training methods.

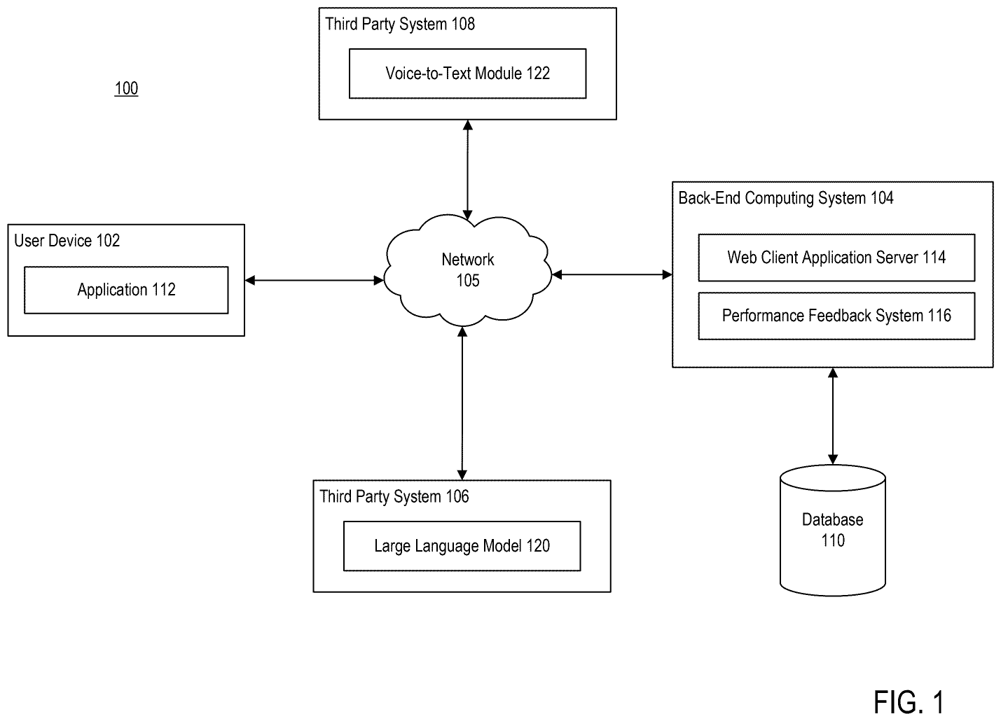

FIG. 1 is a block diagram illustrating a computing environment 100, according to example embodiments. Computing environment 100 may include user device 102, back-end computing system 104, third party system 106, and third party system 108 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data. For example, network 105 may be the Internet, a private data network, virtual private network using a public network and/or other suitable connection(s) that enables components in computing environment 100 to send and receive information between the components of computing environment 100.

User device 102 may be operated by a user. For example, user device 102 may be associated with a sales consultant that interacts with a customer for trading, selling, and negotiating purposes. For example, user device 102 may be associated with a vehicle sales consultant or salesperson at a vehicle dealership. User device 102 may be representative of a mobile device, a tablet, a desktop computer, or any computing system having the capabilities described herein. For example, user device 102 may be representative of a mobile device, a tablet, a desktop computer, or any computer system that allows the user to communicate with a customer via one or more communication channels. One or more communication channels may include a live customer service voice channel, an email correspondence channel, text message correspondence channel, and the like.

User device 102 may include at least application 112. Application 112 may be representative of an application associated with back-end computing system 104. In some embodiments, application 112 may be a standalone application associated with back-end computing system 104, such as a mobile application, tablet application, or, more generally, a software application affiliated with an entity associated with back-end computing system 104. In some embodiments, application 112 may be representative of a web browser configured to communicate with back-end computing system 104.

In some embodiments, application 112 may communicate with a voice-to-text module 122 hosted via third party system 108. Voice-to-text module 122 may be configured to transform verbal communications between a user of user device 102 and a customer to a text-based representation. In some embodiments, voice-to-text module 122 may include a voice-to-text algorithm. In some embodiments, the voice-to-text algorithm may be representative of the Vosk speech recognition toolkit. In some embodiments, application 112 may communicate with voice-to-text module 122 of third party system 108 via one or more application programming interfaces (APIs). For example, application 112 may record communications between a user and customer and may provide the recording to voice-to-text module 122 via one or more APIs. In some embodiments, such voice-to-text transformation may occur real-time, near real-time, or periodically throughout the communication session. In another example, application 112 may stream, in real-time, near real-time, or periodically, the communications between a user and customer to voice-to-text module 122 via one or more APIs. Voice-to-text module 122 may then provide back-end computing system 104 with the text-based representation of the conversation.

In some embodiments, rather than rely on a third party system, such as third party system 108, for a voice-to-text conversion, application 112 may include a local version of a voice-to-text module executing thereon. In such embodiments, user device 102 may provide the transcript of the conversation to back-end computing system 104.

Back-end computing system 104 may include web client application server 114 and performance feedback system 116. Performance feedback system 116 may be comprised of one or more software modules. The one or more software modules are collections of code or instructions stored on a media (e.g., memory of back-end computing system 104) that represent a series of machine instructions (e.g., program code) that implements one or more algorithmic steps. Such machine instructions may be the actual computer code the processor of back-end computing system 104 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

Performance feedback system 116 may be configured to assist users in their conversations with customers in real-time or near real-time when negotiating with customers trading in, purchasing, or financing a vehicle. For example, performance feedback system 116 may provide artificial intelligence generated suggestions on how to overcome customer objections. In some embodiments, an objection may broadly refer to a customer expressing a concern, hesitation, or disagreement related to an aspect of a vehicle purchase, rental, or leasing process. In some embodiments, performance feedback system 116 may further be configured to provide users with professional tips on how to avoid customer objections altogether.

In some embodiments, performance feedback system 116 may be configured to receive transcripts of a conversation between a user and a customer from user device 102 or third party system 106. Performance feedback system 116 may communicate the transcripts of the conversation to large language model 120 hosted on third party system 106 via one or more APIs. An operator or entity associated with performance feedback system 116 may train or fine-tune large language model 120 to identify customer objections in the transcripts and identify an appropriate response based on the objection and overall context of the conversation. In this manner, performance feedback system 116 may assist sales consultants with improving their performance, compared to traditional group training methods, leading to improved sales performance.

In some embodiments, large language model 120 may be representative of one or more third party large language models, such as, but not limited to ChatGPT commercially available from OpenAI, Bard from Google, and the like. In some embodiments, large language model 120 may be representative of an internally developed model associated with an entity associated with back-end computing system 104.

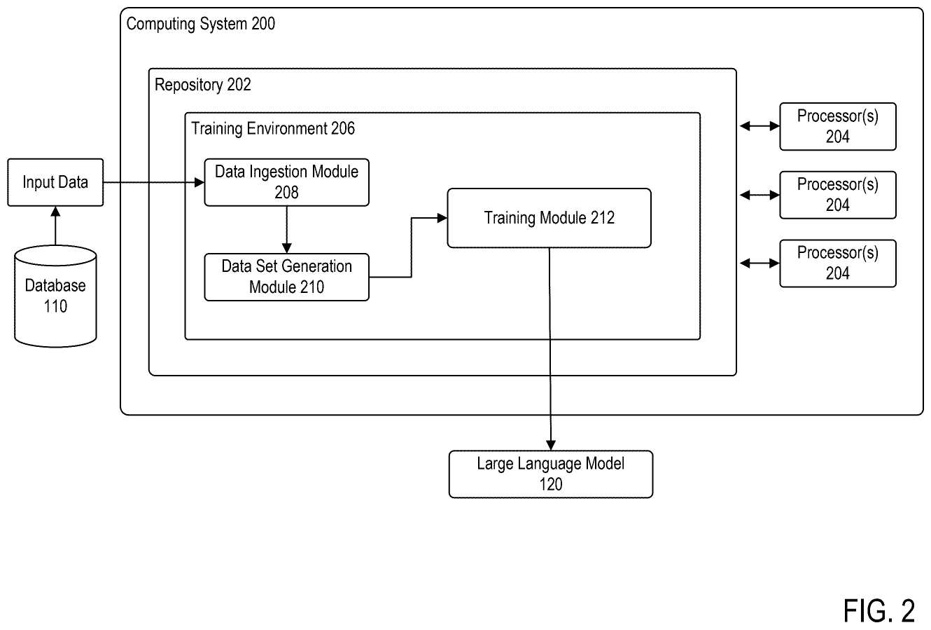

FIG. 2 is a block diagram illustrating a computing system 200, according to example embodiments. As shown, FIG. 2 may represent a training environment in which a large language model is trained or fine-tuned to identify customer objections and provide suggested responses for handing the identified customer objections. Computing system 200 may include a repository 202 and one or more computer processors 204.

Repository 202 may be representative of any type of storage unit and/or device (e.g., a file system, database, collection of tables, or any other storage mechanism) for storing data. Further, repository 202 may include multiple different storage units and/or devices. The multiple different storage units and/or devices may or may not be of the same type or located at the same physical site. As shown, repository 202 includes at least training environment 206.

Training environment 206 may include data ingestion module 208, data set generation module 210, and training module 212. Each of data ingestion module 208, data set generation module 210, and training module 212 may include one or more software modules. The one or more software modules can be collections of code or instructions stored on a media (e.g., memory of computing system 200) that represent a series of machine instructions (e.g., program code) that implements one or more algorithmic steps. Such machine instructions may be the actual computer code the processor of computing system 200 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

Data ingestion module 208 may be configured to receive input data from database 110. Input data may largely be representative of historical conversations between users and customers. In some embodiments, the historical conversations may be text-based conversations. In some embodiments, the historical conversations may be voice-based conversations that were transformed to text.

Data set generation module 210 may be configured to generate training and/or test data sets for training module 212 based on the input data received from database 110. In some embodiments, data set generation module 210 may include a plurality of historical conversations. The plurality of historical conversations may include a plurality of customer objections. Each customer objection may include a pre-generated response for addressing the customer objection. Each conversation of the plurality of historical conversations may include an indication of whether the communication session between the user and the customer was successful. In some embodiments, a successful communication session may be a communication session in which a user successfully navigated a transaction with a customer. In some embodiments, a successful transaction may broadly refer to an occurrence when a sales consultant effectively addresses customer objections, leading to a continued conversation that progresses towards the ends of the sales funnel and ultimately results in a successful state.

Training module 212 may be configured to train or fine tune large language model 120 based on the training data set. For example, training module 212 may train or fine tune large language model 120 to identify customer objections, understand the context of the customer objections, and appropriately responds with a pre-generated response. By meticulously feeding large language model 120 with word-for-word objections and corresponding responses, training module 212 may enable large language model 120 to learn and teach effective objection handling techniques to users.

In some embodiments, large language model 120 may also be capable of learning and adapting over time, allowing it to continuously improve its performance and the effectiveness of the training it provides.

In some embodiments, training module 212 may further train or fine-tune large language model 120 to generate sales tips or tricks to users. For example, training module 212 may train or fine-tune large language model 120 to learn what specific step or steps were missed by a sales consultant resulting in a specific objection. Through this process, large language model 120 may learn to generate valuable insights for sales consultants to proactively address and prevent specific customer objections by incorporating a key step within the sales process.

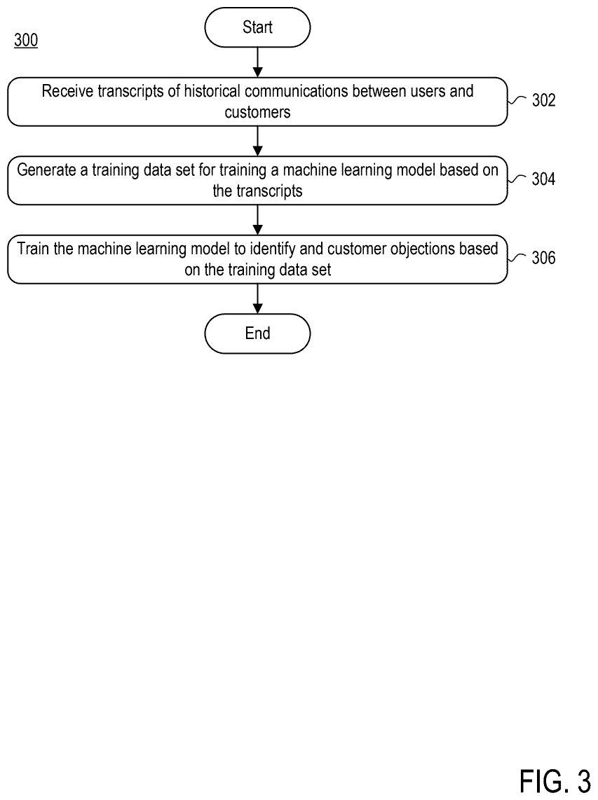

FIG. 3 is a flow diagram illustrating a method 300 of training a machine learning model to guide a user through a conversation with a customer, according to example embodiments. Method 300 may begin at step 302.

At step 302, computing system 200 may receive transcripts of historical communications between users and customers. For example, computing system 200 may be configured to receive input data from database 110. Input data may largely be representative of historical conversations between users and customers. In some embodiments, the historical conversations may be text-based conversations. In some embodiments, the historical conversations may be voice-based conversations that were transformed to text.

At step 304, computing system 200 may generate a training data set for training a machine learning model based on the transcripts. Computing system 200 may generate training and/or test data sets for training the machine learning model based on the historical communications received from database 110. In some embodiments, the training and/or test data sets may include a plurality of historical conversations. Each conversation of the plurality of historical conversations may include an indication of whether the communication session between the user and the customer was successful. In some embodiments, a successful communication session may be a communication session in which a user successfully navigated a transaction with a customer.

At step 306, computing system 200 may train or fine-tune large language model 120 to identify customer objections and provide a pre-generated response based on the training and/or test data sets. Computing system 200 may train or fine-tune large language model 120 to identify customer objections, understand the context of the customer objections, and appropriately responds with a pre-generated response. In this manner, large language model 120 may effectively learn effective objection handling techniques. Computing system 200 may also train machine learning model to generate sales tips or tricks to users. For example, training module 212 may train or fine-tune large language model 120 with a plurality of sales processes on a step-by-step basis. Training module 212 may then train or fine-tune large language model 120 to learn what specific step or steps were missed by a sales consultant resulting in a specific objection. Through this process, large language model 120 may learn to generate valuable insights for sales consultants to proactively address and prevent specific customer objections by incorporating a key step within the sales process. By equipping consultants with this knowledge, they can effectively navigate a customer's concerns, thus minimizing the likelihood of encountering similar objections in the future.

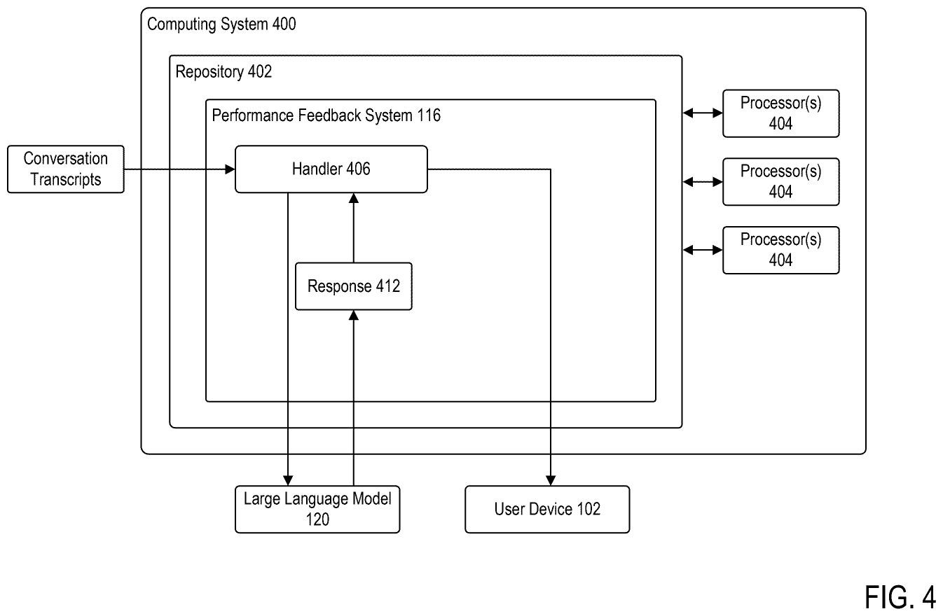

FIG. 4 is a block diagram illustrating a computing system 400, according to example embodiments. As shown, FIG. 4 may represent a deployment environment in which performance feedback system 116 be deployed to guide a user through a conversation with a customer. Computing system 400 may include a repository 402 and one or more computer processors 404.

Repository 402 may be representative of any type of storage unit and/or device (e.g., a file system, database, collection of tables, or any other storage mechanism) for storing data. Further, repository 402 may include multiple different storage units and/or devices. The multiple different storage units and/or devices may or may not be of the same type or located at the same physical site. As shown, repository 402 includes at performance feedback system 116.

In operation, performance feedback system 116 may receive conversation transcripts of a conversation between a user and a customer. In some embodiments, performance feedback system 116 may receive conversation transcripts in real-time or near real-time, such that performance feedback system 116 may provide the user with real-time or near real-time guidance through the conversation.

Handler 406 may provide the transcripts of the conversation to large language model 120 for analysis. For example, handler 406 may provide large language model 120 with the transcripts in real-time, near real-time, or periodically via one or more APIs. Large language model 120 may analyze the conversion transcripts to determine whether the customer has objected to a statement from the user. Responsive to identifying an objection, large language model 120 may identify a corresponding pre-generated response that maps to the objection based on the context of the objection. Large language model 120 may then provide the identified pre-generated response (e.g., response 412) to handler 406. Handler 406 may, in turn, provide the pre-generated response to user device 102 for display.

In some embodiment, response 412 may be provided to the user in the form of a message or pop-up. The message or pop-up may indicate that a potential customer objection has been identified and may include selected response 412 as a suggested response for the user to send to the customer. In this manner, a user may be free to modify the suggested response or provide the suggested response as-is to the customer.

In some embodiments, performance feedback system 116 may provide user device 102 with tips or tricks generated by large language model 120 based on the context of the transcript. In essence, performance feedback system 116 may train the user during the communication session.

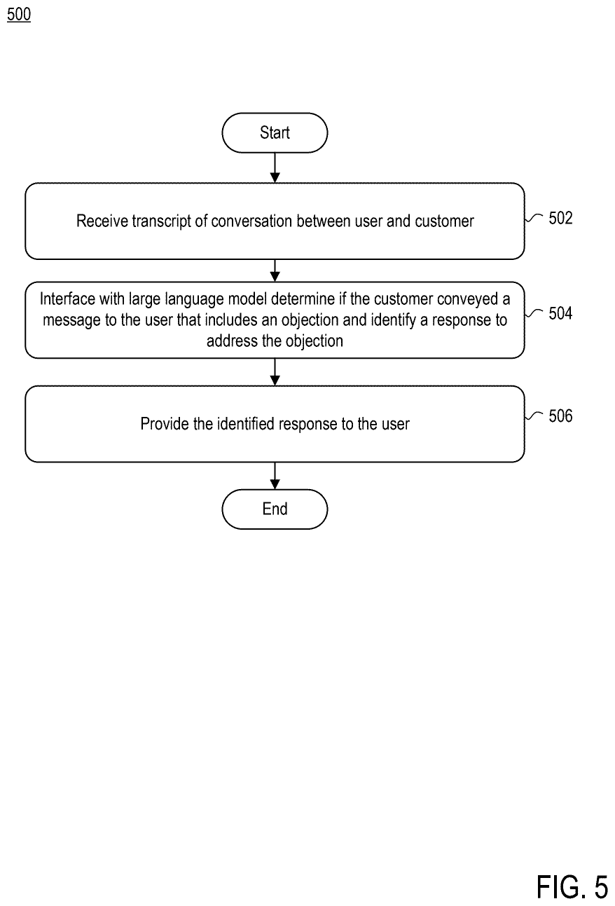

FIG. 5 is a flow diagram illustrating a method 500 of using artificial intelligence to guide a user through a conversation with a customer, according to example embodiments. Method 500 may begin at step 502.

At step 502, computing system 400 may receive a transcript of an ongoing conversation between a user and a customer. For example, performance feedback system 116 may receive conversation transcripts of a conversation between a user and a customer. In some embodiments, performance feedback system 116 may receive conversation transcripts in real-time or near real-time, such that performance feedback system 116 may provide the user with real-time or near real-time guidance through the conversation.

At step 504, computing system 400 may interface with large language model 120 to determine if the customer conveyed a message to the user that includes an objection and identify a response to address the objection. For example, performance feedback system 116 may provide large language model 120 with the transcripts in real-time, near real-time, or periodically via one or more APIs. Large language model 120 may analyze the conversion transcripts to determine whether the customer has objected to a statement from the user. Responsive to identifying an objection, large language model 120 may identify a corresponding pre-generated response that maps to the objection based on the context of the objection. Large language model 120 may then provide the identified pre-generated response to performance feedback system 116.

At step 506, computing system 400 may provide the identified response to user device 102. In some embodiment, the identified response may be provided to user device 102 in the form of a message or pop-up. The message or pop-up may indicate that a potential customer objection has been identified and may include the identified response as a suggested response for the user to send to the customer.

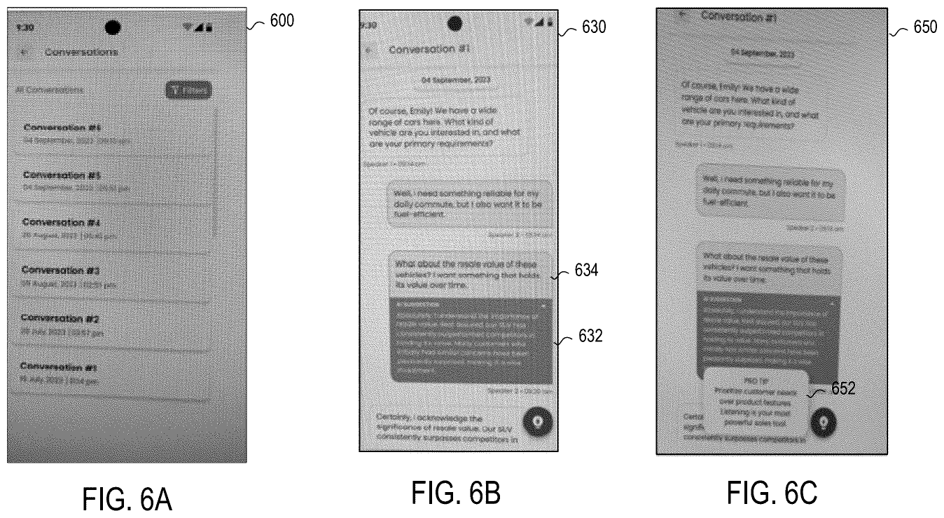

FIGS. 6A-5C illustrate exemplary graphical user interfaces (GUIs) associated with application 112 executing on user device 102, according to example embodiments. As shown, FIG. 6A illustrates GUI 600. GUI 600 represents a plurality of historical conversations between a user of user device 102 and various customers. A user may click or select any of the plurality of historical conversations to view the details of that conversation.

FIG. 6B illustrates GUI 630. GUI 630 may be presented to the user responsive to the user selection Conversation #1 from GUI 600. As shown, GUI 630 includes a plurality of messages between a user of user device 102 and a customer. GUI 630 may include a suggested message 632. Suggested message 632 may be generated responsive to large language model 120 determining that message 634 from the customer included an objection. Suggested message 632 may only be visible to user of user device 102, such that the user of user device 102 may formulate the response to the customer based on suggested message 632.

FIG. 6C illustrates GUI 650. GUI 650 illustrates the same conversation between the user and the customer as shown in GUI 630. GUI 650 further includes a tip message 652. Tip message 652 may be generated by large language model 120 and used to train the user regarding the sales process. Tip message 652 may be provided as an overlay message on top of the conversation.

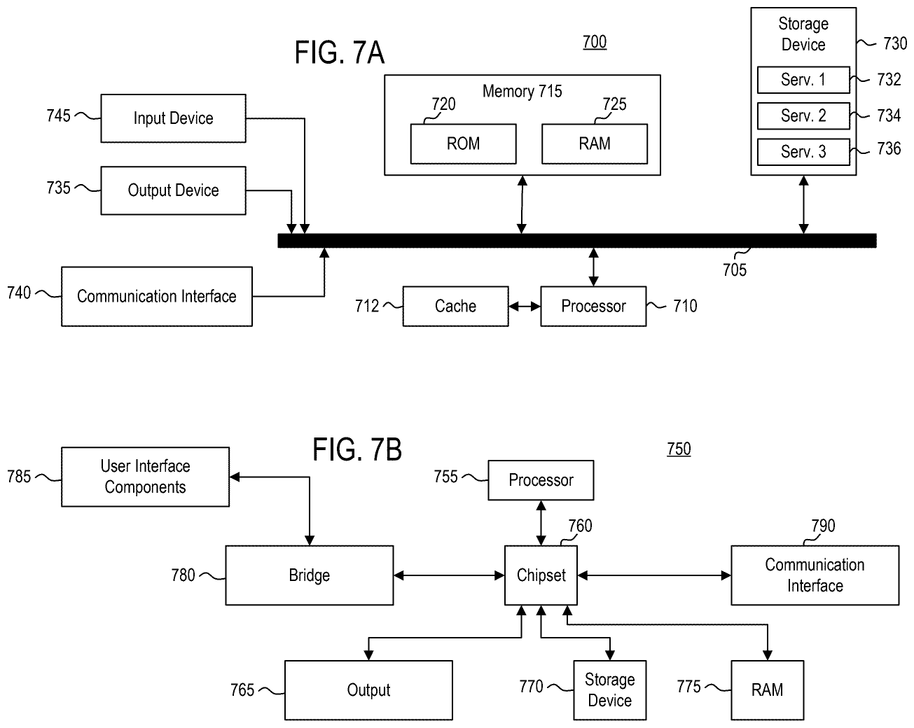

FIG. 7A illustrates a system bus architecture of computing system 700, according to example embodiments. System 700 may be representative of at least of user device 102, back-end computing system 104, computing system 200, and/or computing system 400. One or more components of system 700 may be in electrical communication with each other using a bus 705. System 700 may include a processing unit (CPU or processor) 710 and a system bus 705 that couples various system components including the system memory 715, such as read only memory (ROM) 720 and random-access memory (RAM) 725, to processor 710.

System 700 may include a cache of high-speed memory connected directly with, in close proximity to, or integrated as part of processor 710. System 700 may copy data from memory 715 and/or storage device 730 to cache 712 for quick access by processor 710. In this way, cache 712 may provide a performance boost that avoids processor 710 delays while waiting for data. These and other modules may control or be configured to control processor 710 to perform various actions. Other system memory 715 may be available for use as well. Memory 715 may include multiple different types of memory with different performance characteristics. Processor 710 may include any general-purpose processor and a hardware module or software module, such as service 1 732, service 2 734, and service 3 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction with the computing system 700, an input device 745 may represent any number of input mechanisms, such as a microphone for speech, a touch-sensitive screen for gesture or graphical input, keyboard, mouse, motion input, speech and so forth. An output device 735 may also be one or more of a number of output mechanisms known to those of skill in the art. In some instances, multimodal systems may enable a user to provide multiple types of input to communicate with computing system 700. Communications interface 740 may generally govern and manage the user input and system output. There is no restriction on operating on any particular hardware arrangement and therefore the basic features here may easily be substituted for improved hardware or firmware arrangements as they are developed.

Storage device 730 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 725, read only memory (ROM) 720, and hybrids thereof.

Storage device 730 may include services 732, 734, and 736 for controlling the processor 710. Other hardware or software modules are contemplated. Storage device 730 may be connected to system bus 705. In one aspect, a hardware module that performs a particular function may include the software component stored in a computer-readable medium in connection with the necessary hardware components, such as processor 710, bus 705, output device 735 (e.g., display), and so forth, to carry out the function.

FIG. 7B illustrates a computer system 750 having a chipset architecture that may represent at least user device 102, back-end computing system 104, computing system 200, and/or computing system 400. Computer system 750 may be an example of computer hardware, software, and firmware that may be used to implement the disclosed technology. System 750 may include a processor 755, representative of any number of physically and/or logically distinct resources capable of executing software, firmware, and hardware configured to perform identified computations. Processor 755 may communicate with a chipset 760 that may control input to and output from processor 755.

In this example, chipset 760 outputs information to output 765, such as a display, and may read and write information to storage device 770, which may include magnetic media, and solid-state media, for example. Chipset 760 may also read data from and write data to storage device 775 (e.g., RAM). A bridge 780 for interfacing with a variety of user interface components 785 may be provided for interfacing with chipset 760. Such user interface components 785 may include a keyboard, a microphone, touch detection and processing circuitry, a pointing device, such as a mouse, and so on. In general, inputs to system 750 may come from any of a variety of sources, machine generated and/or human generated.

Chipset 760 may also interface with one or more communication interfaces 790 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 755 analyzing data stored in storage device 770 or storage device 775. Further, the machine may receive inputs from a user through user interface components 785 and execute appropriate functions, such as browsing functions by interpreting these inputs using processor 755.

It may be appreciated that example systems 700 and 750 may have more than one processor 710 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method, comprising:
receiving, by a computing system, in real-time or near real-time, a transcript of an ongoing conversation between a first user and an individual via a first user device;
generating, by the computing system, real-time or near real-time feedback to the first user by:
interfacing with a large language model fine-tuned using pairs of historic conversations and corresponding success states to determine that the individual conveyed a message to the first user that includes an objection and generate a proposed response to address the objection based on a context of the ongoing conversation; and
causing, by the computing system, display of the proposed response in real-time or near real-time via the first user device.

2. The method of claim 1, further comprising:
receiving, by the computing system, in real-time or near real-time, a further transcript of the ongoing conversation between the first user and the individual via the first user device;
generating, by the computing system, further real-time or near real-time feedback to the first user by:
interfacing with the large language model to determine that the individual conveyed a further message to the first user that includes a further objection and generate a further proposed response to address the further objection based on a continued context of the ongoing conversation; and
causing, by the computing system, further display of the further proposed response in real-time or near real-time via the first user device.

3. The method of claim 1, further comprising:
receiving, by the computing system, in real-time or near real-time, a further transcript of the ongoing conversation between the first user and the individual via the first user device;
generating, by the computing system, further real-time or near real-time feedback to the first user by:
interfacing with the large language model to identify a continued context of the ongoing conversation and generate a proposed tip for the first user to advance the ongoing conversation; and
causing, by the computing system, further display of the proposed tip in real-time or near real-time via the first user device.

4. The method of claim 1, further comprising:
receiving, by the computing system, in real-time or near real-time, a further transcript of the ongoing conversation between the first user and the individual via the first user device; and
generating, by the computing system, further real-time or near real-time feedback to the first user by:
interfacing with the large language model to identify a continued context of the ongoing conversation and identify a deficient process performed by the first user in the ongoing conversation.

5. The method of claim 1, wherein the ongoing conversation is a sales process, the first user is a sales person, and the individual is a customer.

6. The method of claim 1, wherein the proposed response is a pre-generated response that maps to the objection based on a context of the objection.

7. The method of claim 1, wherein further communications between the first user and the individual are used to further train or fine-tune the large language model.

8. A non-transitory computer readable medium comprising one or more sequences of instructions, which, when executed by a processor, causes a computing system to perform operations comprising:
receiving, by the computing system, in real-time or near real-time, a transcript of an ongoing conversation between a first user and an individual via a first user device;
generating, by the computing system, real-time or near real-time feedback to the first user by:
interfacing with a large language model fine-tuned using pairs of historic conversations and corresponding success states to determine that the individual conveyed a message to the first user that includes an objection and generate a proposed response to address the objection based on a context of the ongoing conversation; and
causing, by the computing system, display of the proposed response in real-time or near real-time via the first user device.

9. The non-transitory computer readable medium of claim 8, further comprising:
receiving, by the computing system, in real-time or near real-time, a further transcript of the ongoing conversation between the first user and the individual via the first user device;
generating, by the computing system, further real-time or near real-time feedback to the first user by:
interfacing with the large language model to determine that the individual conveyed a further message to the first user that includes a further objection and generate a further proposed response to address the further objection based on a continued context of the ongoing conversation; and
causing, by the computing system, further display of the further proposed response in real-time or near real-time via the first user device.

10. The non-transitory computer readable medium of claim 8, further comprising:
receiving, by the computing system, in real-time or near real-time, a further transcript of the ongoing conversation between the first user and the individual via the first user device;
generating, by the computing system, further real-time or near real-time feedback to the first user by:
interfacing with the large language model to identify a continued context of the ongoing conversation and generate a proposed tip for the first user to advance the ongoing conversation; and
causing, by the computing system, further display of the proposed tip in real-time or near real-time via the first user device.

11. The non-transitory computer readable medium of claim 8, receiving, by the computing system, in real-time or near real-time, a further transcript of the ongoing conversation between the first user and the individual via the first user device; and
generating, by the computing system, further real-time or near real-time feedback to the first user by:
interfacing with the large language model to identify a continued context of the ongoing conversation and identify a deficient process performed by the first user in the ongoing conversation.

12. The non-transitory computer readable medium of claim 8, wherein the ongoing conversation is a sales process, the first user is a salesperson, and the individual is a customer.

13. The non-transitory computer readable medium of claim 8, wherein the proposed response is a pre-generated response that maps to the objection based on a context of the objection.

14. The non-transitory computer readable medium of claim 8, wherein further communications between the first user and the individual are used to further train or fine-tune the large language model.

15. A system comprising:
a processor; and
a memory having programming instructions stored thereon, which, when executed by the processor, causes the system to perform operations comprising:
receiving in real-time or near real-time, a transcript of an ongoing conversation between a first user and an individual via a first user device;
generating real-time or near real-time feedback to the first user by:
interfacing with a large language model fine-tuned using pairs of historic conversations and corresponding success states to determine that the individual conveyed a message to the first user that includes an objection and generate a proposed response to address the objection based on a context of the ongoing conversation; and
causing display of the proposed response in real-time or near real-time via the first user device.

16. The system of claim 15, wherein the operations further comprise:
receiving in real-time or near real-time, a further transcript of the ongoing conversation between the first user and the individual via the first user device;
generating further real-time or near real-time feedback to the first user by:
interfacing with the large language model to determine that the individual conveyed a further message to the first user that includes a further objection and generate a further proposed response to address the further objection based on a continued context of the ongoing conversation; and
causing further display of the further proposed response in real-time or near real-time via the first user device.

17. The system of claim 15, wherein the operations further comprise:
receiving in real-time or near real-time, a further transcript of the ongoing conversation between the first user and the individual via the first user device;
generating further real-time or near real-time feedback to the first user by:
interfacing with the large language model to identify a continued context of the ongoing conversation and generate a proposed tip for the first user to advance the ongoing conversation; and
causing further display of the proposed tip in real-time or near real-time via the first user device.

18. The system of claim 15, wherein the operations further comprise:
receiving in real-time or near real-time, a further transcript of the ongoing conversation between the first user and the individual via the first user device; and
generating further real-time or near real-time feedback to the first user by:
interfacing with the large language model to identify a continued context of the ongoing conversation and identify a deficient process performed by the first user in the ongoing conversation.

19. The system of claim 15, wherein further communications between the first user and the individual are used to further train or fine-tune the large language model.

20. The system of claim 15, wherein the proposed response is a pre-generated response that maps to the objection based on a context of the objection.
